(19) United States
(12) Patent Application Publication
(10) Pub. No.: US 2026/0003955 A1
(43) Pub. Date: Jan. 1, 2026

(54) PRIVACY-AWARE MOBILE SECURITY THREAT DETECTION AND LOGGING

(71) Applicant: Samsung Electronics Co., Ltd., Suwon-si (KR)

(72) Inventors: Nicholas Demetri Tolas, San Francisco, CA (US); Michael Cabot Grace, Sunnyvale, CA (US); Hayawardh Vijayakumar, Sunnyvale, CA (US); Robert Lee Harrison, III, Sunnyvale, CA (US); Baibhav Singh, Cupertino, CA (US)

(21) Appl. No.: 19/057,764

(22) Filed: Feb. 19, 2025

Related U.S. Application Data
(60) Provisional application No. 63/666,589, filed on Jul. 1, 2024.

(51) Int. Cl. G06F 21/55; G06F 21/62

(52) U.S. Cl. CPC G06F 21/552; G06F 21/554; G06F 21/6254

(57) ABSTRACT

To detect security threats to an enterprise mobile device with a personal profile and a work profile, detection modules on the enterprise mobile device receive events describing security threats detected in data from the personal profile and the work profile. The received events are stored in a security log on the enterprise mobile device. When requests from a remote entity for stored events, to evaluate security threats against the enterprise mobile device, the events are filtered to remove private data prior to transmission to the remote entity, such that the events are anonymized. The filtering may occur either prior to or after storing the events in the security log.

### CROSS-REFERENCE TO RELATED APPLICATION AND PRIORITY CLAIM

This application claims priority under 35 U.S.C. § 119 (e) to U.S. Provisional Patent Application No. 63/666,589 filed on Jul. 1, 2024, which is hereby incorporated by reference in its entirety.

### TECHNICAL FIELD

This disclosure relates generally to data security. More specifically, this disclosure relates to ensuring data security on mobile devices without compromising user privacy.

### BACKGROUND

When considering security incidents directed toward mobile devices, attackers continue to hack into mobile devices by leveraging device vulnerabilities, malware, and other similar methods. Due to strong privacy restrictions, there is a lack of security information and tooling to detect security incidents systemwide on the device. Specifically, because an application cannot access data across both work and personal domains, there is no approach to know from the work side of the device that the personal side has been compromised. For mobile devices to remain private, no data should leave the device that could potentially disclose private information about a user to an outside enterprise or third party. This limits the ability of commercially available security products to implement necessary defenses against security threats originating from the personal domain. Given that original equipment manufacturers (OEMs) have access to the personal section of the device and have access to information therein, OEMs can implement solutions without revealing sensitive data to another party.

### SUMMARY

This disclosure relates to security for enterprise data that includes or intermingles private user information.

In a first embodiment, a method of detecting security threats to an enterprise mobile device with a personal profile and a work profile includes receiving, from one or more detection modules stored on the enterprise mobile device, events describing security threats detected in data from the personal profile and the work profile. The method also includes storing the events in a security log on the enterprise mobile device. The method further includes receiving a request from a remote entity for events to evaluate security threats against the enterprise mobile device. The method still further includes filtering the events to remove private data such that the events are anonymized, prior to transmitting the events to the remote entity. The method includes transmitting the filtered events to the remote entity.

In a second embodiment, an electronic device for detecting security threats to an enterprise mobile device with a personal profile and a work profile includes at least one processing device. The processing device is configured to receive, from one or more detection modules stored on the enterprise mobile device, events describing security threats detected in data from the personal profile and the work profile. The processing device is also configured to store the events in a security log on the enterprise mobile device. The processing device is further configured to receive a request from a remote entity for events to evaluate security threats against the enterprise mobile device. The processing device is still further configured to filter the events to remove private data such that the events are anonymized, prior to transmitting the events to the remote entity. The processing device is configured to transmit the filtered events to the remote entity.

In a third embodiment, a non-transitory machine readable medium for detecting security threats to an enterprise mobile device with a personal profile and a work profile includes instructions that when executed cause at least one processing device of an electronic device to receive, from one or more detection modules stored on the enterprise mobile device, events describing security threats detected in data from the personal profile and the work profile. The instructions, when executed, also cause the processing device to store the events in a security log on the enterprise mobile device. The instructions, when executed, further cause the processing device to receive a request from a remote entity for events to evaluate security threats against the enterprise mobile device. The instructions, when executed, still further cause the processing device to filter the events to remove private data such that the events are anonymized, prior to transmitting the events to the remote entity. The instructions, when executed, cause the processing device to filter the events to transmit the filtered events to the remote entity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for privacy-aware mobile security threat detection and logging in accordance with this disclosure;

FIG. 2 illustrates an example process of detecting security threats to a mobile device with a personal profile and a work profile in accordance with this disclosure;

FIG. 3 is a diagram illustrating an example detection and logging solution for system-wide threat detection while protecting user privacy in accordance with this disclosure;

FIG. 4 is a diagram illustrating in greater detail the architecture and functionality of on-device threat detection modules in the detection and logging solution of FIG. 3;

FIG. 5 is a diagram illustrating in greater detail the architecture and functionality of off-device querying flow in the detection and logging solution of FIG. 3;

FIG. 6 illustrates an example process of on-device threat detection and logging in accordance with this disclosure; and

FIG. 7 illustrates an example process of off-device query processing in accordance with this disclosure.

### DETAILED DESCRIPTION

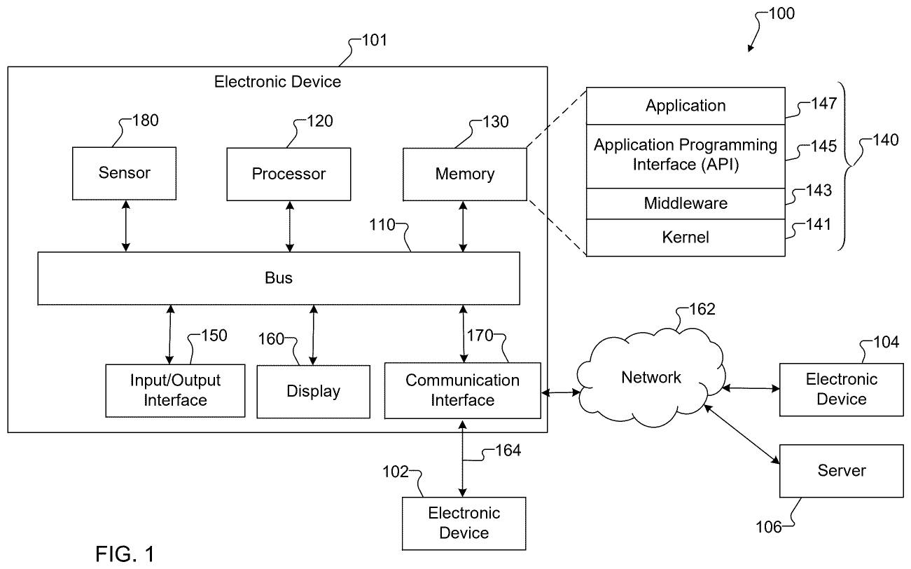

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

On mobile devices for business, there are two separate spaces on a mobile device: a work (business or employer) space and a personal (individual employee) space. These spaces cannot communicate information to each other that could reveal to either the container, the behaviors, or the data possessed. To communicate such information would violate an end user's (personal) privacy or potentially leak sensitive work information. However, this means that threat detection apps utilized for the work space also face the same limitation, having no visibility into the personal space. Accordingly, threat detection for enterprise-enabled devices is currently limited, lacking system-wide visibility due to user data privacy concerns.

There are no threat detection engines that can process raw, potentially sensitive security information across work/personal use case devices. Without visibility into both the work space and the personal space, holistic threat detection is difficult.

FIG. 1 illustrates an example network configuration 100 that may be employed for privacy-aware mobile security threat detection and logging in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to privacy-aware mobile security threat detection and logging.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to privacy-aware mobile security threat detection and logging. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101. In some embodiments, the sensor(s) 180 include at least one camera or other imaging sensor that captures a burst of images, and the electronic device 101 can perform image alignment of two or more images within the captured burst as described in further detail below.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to privacy-aware mobile security threat detection and logging.

Although FIG. 1 illustrates one example of a network configuration 100 including an electronic device 101 employed for privacy-aware mobile security threat detection and logging, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

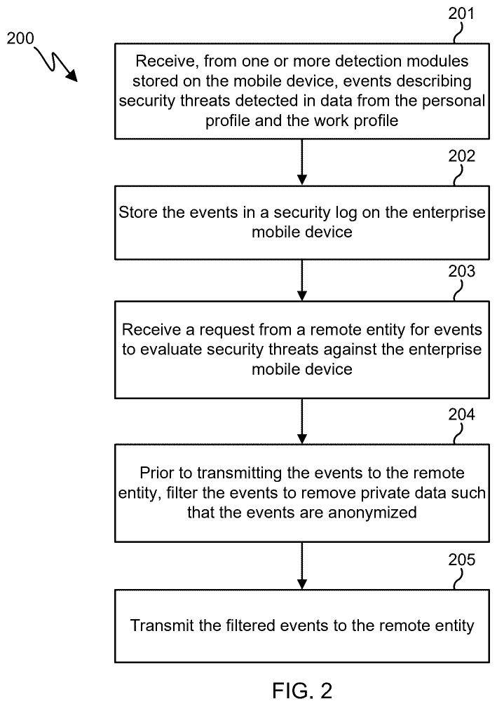

FIG. 2 illustrates an example process 200 of detecting security threats to a mobile device with a personal profile and a work profile in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 begins with receiving, from one or more detection modules stored on the enterprise mobile device, events describing security threats detected in data from at least one of the personal profile and the work profile (step 201). The detection modules may be based on machine learning models, heuristics, or rule-based engines, which may be deployed on the mobile device and may be under an operating system layer of the mobile device. Events corresponding to detected security threats are stored in a security log on the enterprise mobile device (step 202). The events may optionally be organized or tagged to indicate whether data from the personal profile. A request from a remote (off-device) entity is received (step 203), for logged events to allow the remote entity to evaluate security threats against the mobile device. An on-device framework may be provided for handling these requests. Prior to transmitting events to the remote entity, the events may be filtered to remove private data (step 204), such that the events are anonymized. The filtering may occur prior to storing in the security log, and may be based on a privacy budget limiting an amount of information relating to a particular user identity from being transmitted to the remote entity, or may be based on rules defining certain types of details in the events as private. The filtered events are transmitted to the remote entity (step 205).

Although FIG. 2 illustrates one example of a process 200 of collecting and connecting information to create memory stream content, various changes may be made to FIG. 2. For example, while shown as a series of steps, various steps in FIG. 2 could overlap, occur in parallel, occur in a different order, or occur any number of times (including zero times).

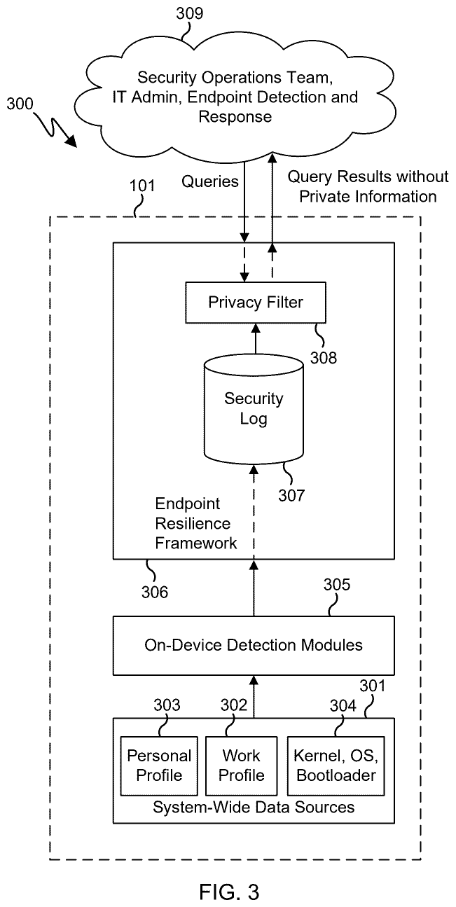

FIG. 3 is a diagram illustrating an example detection and logging solution 300 for system-wide threat detection while protecting user privacy in accordance with this disclosure. For ease of explanation, the detection and logging solution 300 of FIG. 3 is described as being implemented within the electronic device 101 in the network configuration 100 of FIG. 1, and interacting with (for example) the server 106. However, the detection and logging solution 300 may be implemented using any other suitable device(s) and in any other suitable system(s).

In the detection and logging solution 300 of FIG. 3, device memory 301 (e.g. memory 130) contains a work profile 302 storing work-related data, a personal profile 303 storing data personal to the user, and various software 304 such as a kernel, a bootloader, operating system software, apps, etc. The enterprise employing the user of the electronic device 101 can be liable for a breach of the security of data within the work profile 302. However, attacks nominally or initially targeting data within the personal profile 303 may threaten or eventually compromise the security of the data within the work profile 302. Nonetheless, there are reasons for the enterprise to avoid accessing aspects of the data within the personal profile 303 that are private to the user.

On-device detection modules 305 collect data from the entire system (including the work space corresponding to the work profile 302 and the personal space corresponding to the personal profile 303), thus enabling holistic system-wide threat detection. On-device detection modules 305 access system-wide data sources, including datapoints from multiple sources that span personal and workspaces and privileged layers of the software stack (e.g., Operating System, Bootloader). An OEM has unique visibility into both the personal space and privileged layers of the software stack that third parties do not have All detection modules run on-device, thus ensuring that no private data ever leaves the device for purposes of threat detection. As discussed below, data to be exported off-device is sanitized to remove private information. The on-device detection modules 305 consume system-wide data, detect threats, and generate events that contain information about detected threats. On-device threat detection may be performed using techniques such as machine learning (ML) models, heuristics, and rule-based engines. For example, phishing detection may use an ML-model. The on-device detection modules 305 generate events corresponding to detected threats.

An endpoint resilience framework 306 is responsible for logging events from the on-device detection modules 305, and for handling queries and filtering private information. The endpoint resilience framework 306 includes a security log 307, a tamper-evident log that stores information about events from the on-device detection modules 305. The endpoint resilience framework 306 also includes a privacy filter 308, which filters out private information from the security log 307 in response to remote queries for threat event information stored in that security log 307. (As used herein, “remote” merely means that the query originates outside the user device or has potential for private user information being made accessible outside of the user device). Private information can be filtered using several techniques, such as a definition of which details of an event are private and differential privacy using a privacy budget.

The detection and logging solution 300 involves remote entities 309, off-device entities that interact with the electronic device 101 to fetch threat event information for various purposes such as compliance, device administration, and threat hunting. Examples of these remote entities are IT administrators, Security Operation teams, and Endpoint Detection and Response Systems. The remote entities 309 submit queries relating to data security to the endpoint resilience framework 306. The endpoint resilience framework 306 replies to those queries with results having been sanitized of private information.

Although FIG. 3 illustrates one example of a detection and logging solution 300, various changes may be made to FIG. 3. For example, while shown as a series of functions arranged in a particular order, various functions in FIG. 3 could be arranged in a different order or operate in parallel.

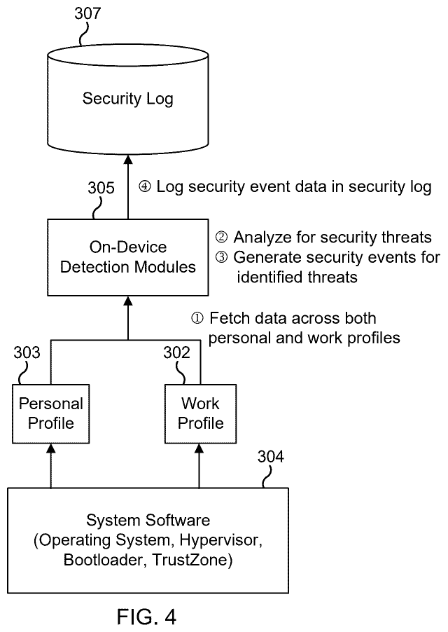

FIG. 4 is a diagram illustrating in greater detail the architecture and functionality of on-device threat detection modules 305 in the detection and logging solution 300 of FIG. 3. As with the detection and logging solution 300 of FIG. 3, the functionality of on-device threat detection modules 305 is described as being implemented within the electronic device 101 in the network configuration 100 of FIG. 1 for ease of explanation.

As shown in FIG. 4, the on-device threat detection modules 305 fetch data across both the personal profile 303 and the work profile 302. The on-device threat detection modules 305 analyze the data that has been fetched for security threats, and generate security events for identified threats. The on-device threat detection modules 305 log security event details in the security log 307.

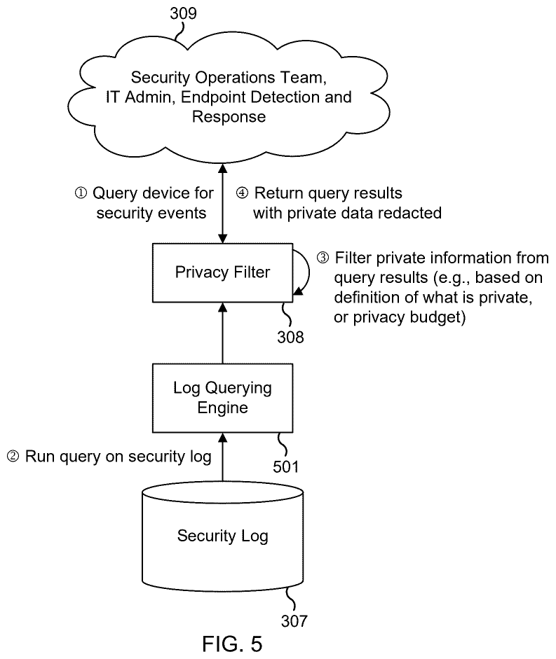

FIG. 5 is a diagram illustrating in greater detail the architecture and functionality of off-device querying flow in the detection and logging solution 300 of FIG. 3. As with the detection and logging solution 300 of FIG. 3, the functionality of the off-device querying flow is described as being implemented at least partially within the electronic device 101 in the network configuration 100 of FIG. 1 for ease of explanation.

As shown in FIG. 5, remote entities 309 query the electronic device 101 for security events. In response to the query, the security log 307 forwards security events, at least some of which may derive from data within the personal profile 303. The privacy filter 308 redacts private information from the query results, based on definitions of what constitutes data private to the user or a privacy budget, as discussed in further detail below. The query results with private data redacted are then returned to the remote entities 309 in response to the query.

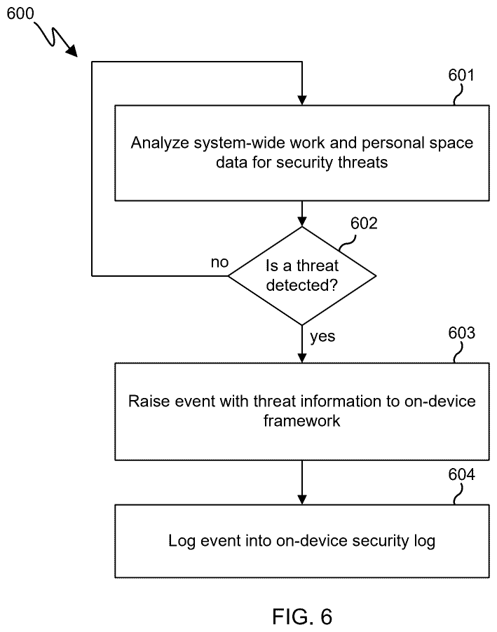

FIG. 6 illustrates an example process 600 of on-device threat detection and logging in accordance with this disclosure. For ease of explanation, the process 600 of FIG. 6 is described as being performed using the electronic device 101 in the network configuration 100 of FIG. 1. However, the process 600 may be performed using any other suitable device(s) and in any other suitable system(s).

As shown in FIG. 6, the process 600 begins with analysis of system-wide work and personal space data for security threats (step 601). This analysis is performed on the device, so the presence of private user data within the personal space data does not result in such private information being compromised or exfiltrated. A determination is then made as to whether any threat was detected based on the system-wide data analysis (step 602). The identification of threats encompasses attacks that at least initially target only the personal space as well as those targeting the work space, such that attacks which could potentially result in lateral attacks from the personal space into the work space may be detected. Various on-device threat detection techniques may be employed, including use of heuristics or rules, or through trained ML models deployed on the user device (e.g., to identify phishing attacks). If a threat is detected, an event with the threat information is raised to the on-device security framework (step 603). The event is raised on the device, so the presence of private user data within the personal space data does not result in such private information being accessed off-device by raising the event. The event is logged into an on-device security log (step 604). The entirety of the process 600 is performed on the user device without the possibility of off-device access of private user information.

Although FIG. 6 illustrates one example of a process 600 of on-device threat detection and logging, various changes may be made to FIG. 6. For example, while shown as a series of steps, various steps in FIG. 6 could overlap, occur in parallel, occur in a different order, or occur any number of times (including zero times).

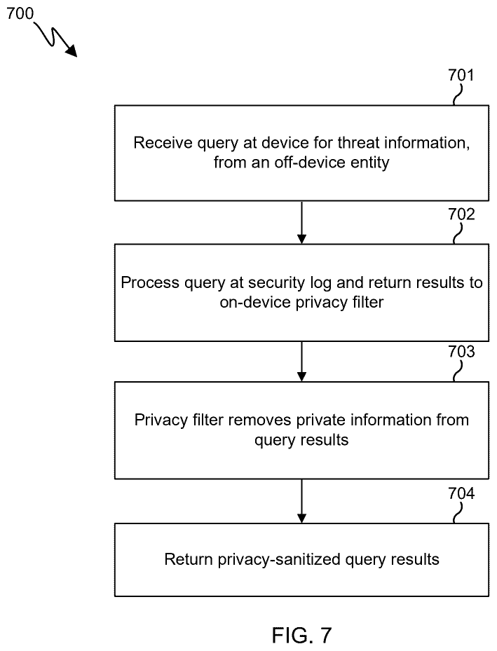

FIG. 7 illustrates an example process 700 of off-device query processing in accordance with this disclosure. For ease of explanation, the process 700 of FIG. 7 is described as being performed using the electronic device 101 in the network configuration 100 of FIG. 1. However, the process 700 may be performed using any other suitable device(s) and in any other suitable system(s).

As shown in FIG. 7, the process 700 begins with receiving, from an off-device entity, any query for threat information stored in the user device (step 701). The query may be directed toward the on-device security log, via the on-device security framework. The received query is processed (e.g., at the on-device security log or by the on-device security framework) and query results are returned to the on-device privacy filter (step 702), and the privacy filter removes private information from the query results (step 703). There are several ways by which a privacy filter can be implemented to filter out private information: One approach involves definition of private details, via a rule defines which details of an event are considered private. For example, for phishing detection, the uniform resource locator (URL) of the phishing site could be considered private information and not shared, whereas the (anonymized) fact that the user accessed a phishing website may be shared without privacy concerns. Another approach involves using a privacy budget in which the privacy filter uses a differential privacy algorithm (the output of which output does not enable determination of whether a particular individual's information was used in the computation) to ensure that any data shared does not de-anonymize the user. The privacy-sanitized query results are then returned to the querying entity (step 704). The results disclosed or accessible to the off-device entity should not allow determination of private user information.

Although FIG. 7 illustrates one example of a process 700 of on-device threat detection and logging, various changes may be made to FIG. 7. For example, while shown as a series of steps, various steps in FIG. 7 could overlap, occur in parallel, occur in a different order, or occur any number of times (including zero times).

Several example use cases may benefit from the subject matter of the present disclosure:

Compliance: When an enterprise wants to know that a device is compliant with enterprise security policies, one common datapoint required for determining compliance is whether the device has had an unremedied security threat event.

Zero Trust: The zero trust principle is used to evaluate the security posture of the device before allowing the device access to enterprise resources. Again, a common indication of security posture is whether the device has had security incidents in the recent past. The on-device framework described above can gather such data system-wide and send security information off device without compromising user privacy. For example, the framework can send information that a phishing event has occurred without sharing the details of the actual URL (which could be private information).

Threat Hunting: Results of system-wide threat detection can be queried by threat hunting tools such as endpoint detection and response (EDR) systems. The framework can handle queries that provide data about system-wide threats-but after filtering out private information.

Security Operations Center (SOC) Enablement: Currently, SOC analysts have limited visibility into mobile devices (unlike typical enterprise-owned personal computers) due to privacy concerns. The framework provides system-wide visibility for SOC analysts without compromising user privacy.

The solution described above has the ability to perform on-device threat detection using holistic system-wide information across personal and work spaces. The solution described also has the ability to filter and convey non-private information about threats to off-device entities such as the security operations team and information technology (IT) administrators.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method of detecting security threats to an enterprise mobile device with a personal profile and a work profile, the method comprising:
receiving, from one or more detection modules stored on the enterprise mobile device, events describing security threats detected in data from the personal profile and the work profile;
storing the events in a security log on the enterprise mobile device;
receiving a request from a remote entity for events to evaluate security threats against the enterprise mobile device;
prior to transmitting the events to the remote entity, filtering the events to remove private data such that the events are anonymized; and
transmitting the filtered events to the remote entity.

2. The method of claim 1, wherein the one or more detection modules are based on machine learning models, heuristics, or rule-based engines.

3. The method of claim 2, wherein the one or more detection modules are based on trained machine-learning models deployed on the enterprise mobile device.

4. The method of claim 1, wherein the one or more detection modules are under an operating system (OS) layer of the enterprise mobile device.

5. The method of claim 1, wherein filtering the events occurs prior to storing the events in the security log.

6. The method of claim 1, wherein filtering the events is based on a privacy budget limiting an amount of information relating to a particular user identity from being transmitted to the remote entity.

7. The method of claim 1, wherein filtering the events is based on rules defining types of details in the events as private.

8. An electronic device for detecting security threats to an enterprise mobile device with a personal profile and a work profile, the electronic device comprising:
at least one processing device configured to:
receive, from one or more detection modules stored on the enterprise mobile device, events describing security threats detected in data from the personal profile and the work profile;
store the events in a security log on the enterprise mobile device;
receive a request from a remote entity for events to evaluate security threats against the enterprise mobile device;
prior to transmitting the events to the remote entity, filter the events to remove private data such that the events are anonymized; and
transmit the filtered events to the remote entity.

9. The electronic device of claim 8, wherein the one or more detection modules are based on machine learning models, heuristics, or rule-based engines.

10. The electronic device of claim 9, wherein the one or more detection modules are based on trained machine-learning models deployed on the enterprise mobile device.

11. The electronic device of claim 8, wherein the one or more detection modules are under an operating system (OS) layer of the enterprise mobile device.

12. The electronic device of claim 8, wherein filtering the events occurs prior to storing the events in the security log.

13. The electronic device of claim 8, wherein filtering the events is based on a privacy budget limiting an amount of information relating to a particular user identity from being transmitted to the remote entity.

14. The electronic device of claim 8, wherein filtering the events is based on rules defining types of details in the events as private.

15. A non-transitory machine readable medium for detecting security threats to an enterprise mobile device with a personal profile and a work profile, the non-transitory machine readable medium comprising instructions that when executed cause at least one processing device of an electronic device to:
receive, from one or more detection modules stored on the enterprise mobile device, events describing security threats detected in data from the personal profile and the work profile;
store the events in a security log on the enterprise mobile device;
receive a request from a remote entity for events to evaluate security threats against the enterprise mobile device;
prior to transmitting the events to the remote entity, filter the events to remove private data such that the events are anonymized; and
transmit the filtered events to the remote entity.

16. The non-transitory machine readable medium of claim 15, wherein the one or more detection modules are based on machine learning models, heuristics, or rule-based engines.

17. The non-transitory machine readable medium of claim 16, wherein the one or more detection modules are based on trained machine-learning models deployed on the enterprise mobile device.

18. The non-transitory machine readable medium of claim 15, wherein the one or more detection modules are under an operating system (OS) layer of the enterprise mobile device.

19. The non-transitory machine readable medium of claim 15, wherein filtering the events occurs prior to storing the events in the security log.

20. The non-transitory machine readable medium of claim 15, wherein filtering the events is based on a privacy budget limiting an amount of information relating to a particular user identity from being transmitted to the remote entity.
